(19) United States
(12) Patent Application Publication
(10) Pub. No.: US 2025/0051145 A1
(43) Pub. Date: Feb. 13, 2025

(54) TOWER CLIMBING MECHANISM

(71) Applicant: Aydin Okurogullari, Istanbul (TR)

(72) Inventor: Aydin Okurogullari, Istanbul (TR)

(21) Appl. No.: 18/720,696

(22) PCT Filed: Dec. 30, 2021
(86) PCT No.: PCT/TR2021/051649

§ 371 Date: Jun. 17, 2024

(51) Int. Cl. B66C 23/32; B66C 23/20

(52) U.S. Cl. CPC B66C 23/32; B66C 23/207

(57) ABSTRACT

The present invention relates to a climbing mechanism used by mounting a crane on it. The climbing mechanism can climb along the tower on the outer surface of the tower. It reduces the installation cost, as there is no need to use the largest cranes used for tower installation. It provides for the installation of towers higher than the height that the largest cranes can reach.

### TECHNICAL AREA

The present invention relates to a climbing mechanism on which a special crane is mounted. Climbing mechanism; narrowing upwards; in conical structure; In a modular tower or cylindrical structure consisting of polygonal cross-section modules added on top of each other, it allows the tower assembly to be made by climbing up on the wall of the wind turbine tower or similar towers.

### STATE OF THE ART

As it is known, the wind speed increases as it rises from the ground. Increasing wind speed increases the efficiency of the turbine by producing more electricity. For this reason, turbine manufacturers design turbines and towers operating at higher altitudes. In 2021, the tower heights reached 180 meters. It will exceed 250 meters in the near future. The largest cranes are used for the assembly of wind turbine towers. These cranes have long transportation, installation and relocation times and high costs. In addition, the capacities of the existing cranes may be insufficient due to the tower heights that have increased in recent years and will increase further in the future. In recent years, mechanisms that provide maintenance of tower elements by climbing on the tower have been developed. These mechanisms have side arms that prevent wobble and provide balance. On some models these side arms are wrapped around the turret body. The side arms wrapped around the tower body may cause damage to the tower elements.

In another model, the side arms are fixed to the holes in the tower with the help of a pin on the arms. However, there may be difficulties in performing this procedure.

According to the invention; some special purpose-built cranes in the market can be mounted on a mechanism that climbs along the tower wall during the assembly phase of the tower, and the tower can be assembled. The side arms of the climbing mechanism have U bearings. Each module in the tower has pins mounted against each other. The U bearings on the side arms are fixed to these pins by moving them in the y and z axes. Thanks to this feature; fixing the side arms to the tower is easier than prior art. This prevents the climbing mechanism from wobbling in the tower. In addition, thanks to the guide rail mounted on the tower, all forces from the crane are transmitted to the foundation uninterruptedly through the guide rail and tower elements.

The module height of the modular towers is around 12-13 meters. The first three modules of the tower; It can be done with the help of a mobile crane, which is smaller than the largest cranes. After this stage, the climbing mechanism is mounted on the wall of the tower. A special crane can be mounted on the climbing mechanism, and modules after the third module and other elements of the wind turbine can be mounted with this crane. The climbing mechanism, thanks to its components working on the principle of elevator, is raised by one module height and the next module is mounted. This process is repeated throughout the tower, completing the tower assembly. Finally, the assembly of the wind turbine is completed by mounting the elements of the turbine such as the nacelle, rotor and blades.

The economic life of wind turbines is around 20-25 years. For malfunctions that may occur in this process, one of the biggest cranes should be brought to the power plant area and used. This means a huge cost. However, the maintenance of the tower elements and equipment assembled using the climbing mechanism described in the present invention can be done using the climbing mechanism.

### PURPOSE OF THE INVENTION

The invention is a solution to reduce installation time and cost by enabling the erection of high towers without the use of large cranes.

The following are the advantages of the invention.
The climbing mechanism can be more easily mounted on the pins in the tower thanks to the U bearings on the side arms;
Thanks to the guide rail mounted on the tower, all the forces coming from the crane are transmitted to the foundation uninterruptedly through the guide rail and tower elements.
Thanks to the support rods, the forces on the guide rail are transmitted to the other tower elements in the module and become a distributed load;
High crane cost is reduced as there is no need to use very large cranes;
Since it is used by climbing the tower, it allows to build higher towers than very large cranes can reach;
It can be used again in case of malfunctions that may occur after the wind turbine is put into operation;

The disadvantages of the invention are as follows;
In order to use the invention, some parts (such as guide rail, king pins, support bars) must be fixed to the tower during the production of the tower;

### EXPLANATION OF FIGURES

1 Overview
2 Climbing mechanism overview
3 Main components of the climbing mechanism
4 Outer skid
5 Outer skid attachment zone
6 Hanger part
7 Side arm assembly
8 U slot group
9 Inner skid
10 Wheel group
11 Wheel assembly top view
13 Working principle of elevator
14 Carrier chassis and shell views
15 Guide rail view
16 King pin slot view
17 King pin-tower element wall mounting view
18 Support bar assembly view
21 Climbing mechanism working views

### EXPLANATION OF REFERENCES IN FIGURES

1 Climbing mechanism
2 Crane
3 Crane connection platform
4 Tower
5 Remote control room
6 Inner skid
8 Outer skid
9 Elevator
17 Carrier chassis
18 Shell
19 Door
20 Hydraulic tank
21 Hydraulic valve group
22 Electrical and electronic control panel
23 Platform
24 Side arm assembly
26 Hydraulic cylinder
27 Hydraulic cylinder
29 Guide bearing
30 Reinforcement part
31 Reinforcement part
32 Reinforcement part
33 Stairs
36 Feder
39 Hanger part
40 Hanger part
41 Hydraulic cylinder
42 Skid column
43 Reinforcement part
44 Reinforcement part
45 Side arm
46 Side arm
47 Side arm
48 Side arm
53 Reinforcement part
54 Reinforcement part
55 Reinforcement part
56 Bracket
57 Guide tube
58 Hydraulic cylinder
59 Hole
67 Lock pin
70 Side arm inner column
73 Reinforcement part
74 Reinforcement part
75 Guide bearing
76 Side arm inner column
77 Hydraulic cylinder
78 King pin
79 Skid bearing
80 Hydraulic cylinder
81 U slot group
82 Camera arm
83 Camera
84 Camera arm
86 Skid column
88 Skid part
89 Reinforcement part
90 U slot
91 Hanger part
92 Hanger part
93 Reinforcement part
94 Reinforcement part
103 Wheel
104 Wheel
105 Wheel group
106 Bushing body
107 Bushing body
108 Shaft
109 Shaft
110 Pin
113 Bolt hole
114 Bolt hole
116 Tower module
117 Tower element
118 Guide rail
119 Hole
122 Connecting part
123 King pin slot
124 King pin bushing
125 Metal plate
126 Support plate
127 Angle
128 Bolt
131 Support bar
132 Flange
133 y-z cross section

### DISCLOSURE OF THE INVENTION

(001) The invention relates to a climbing mechanism (1) that climbs upwards along the tower on the outer wall of the tower. Thanks to the crane (2) mounted on it, it enables the elements of the tower and other structural elements to be lifted up to the top of the tower. The crane can be purchased ready-made and integrated into the climbing mechanism.

Components and parts of the climbing mechanism (1) in sections (002 . . . 018); Parts that should be in the tower in sections (019 . . . 022); In chapters (023 . . . 026) the working method of the climbing mechanism (1) is explained.

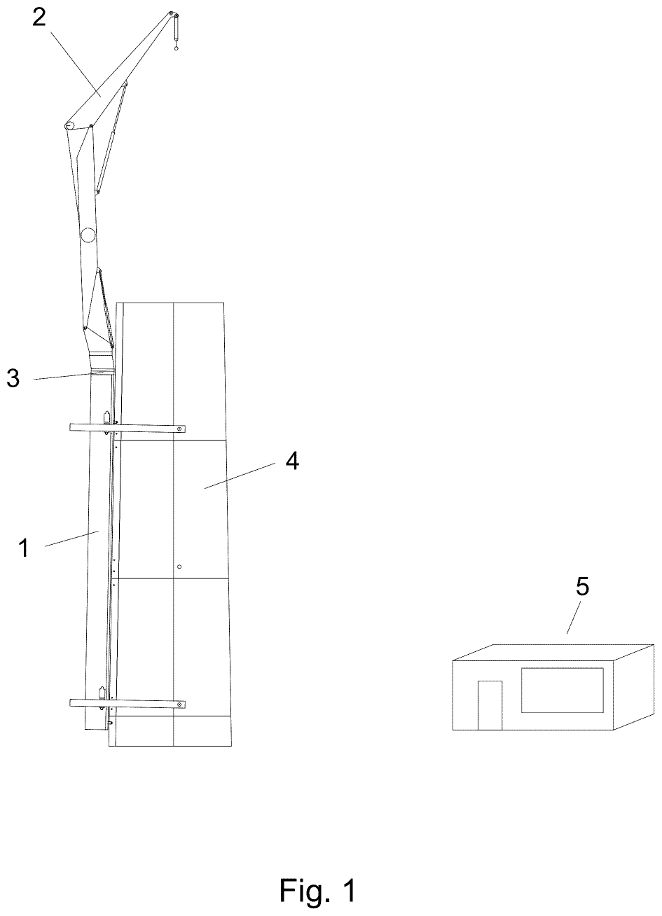

(002) FIG. 1 shows the general view of the crane (2), the modular tower (4) and the remote control room (5) mounted on the crane connection platform (3) in a climbing mechanism (1).

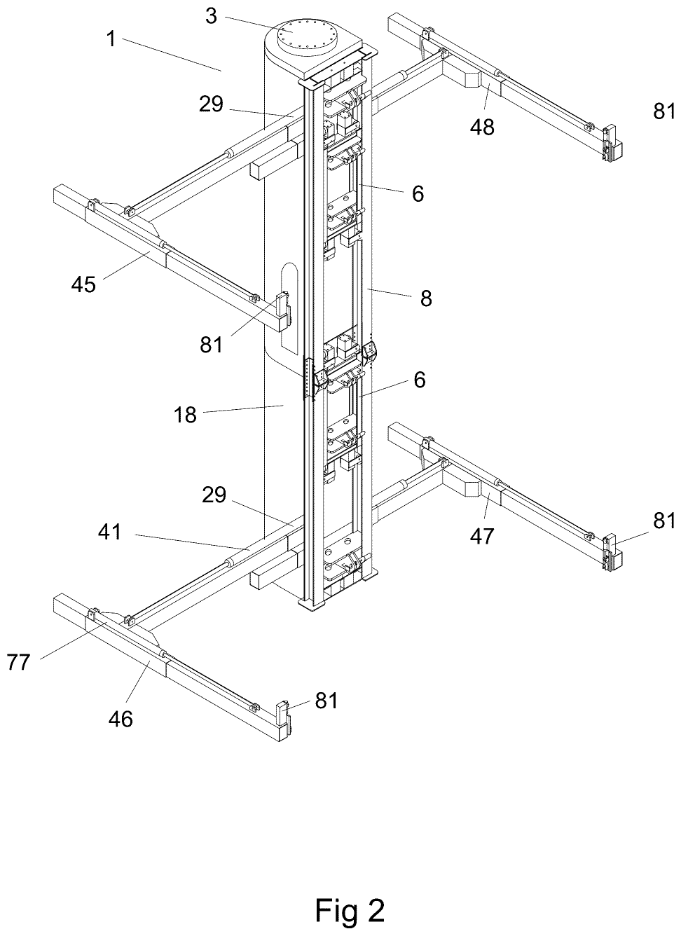

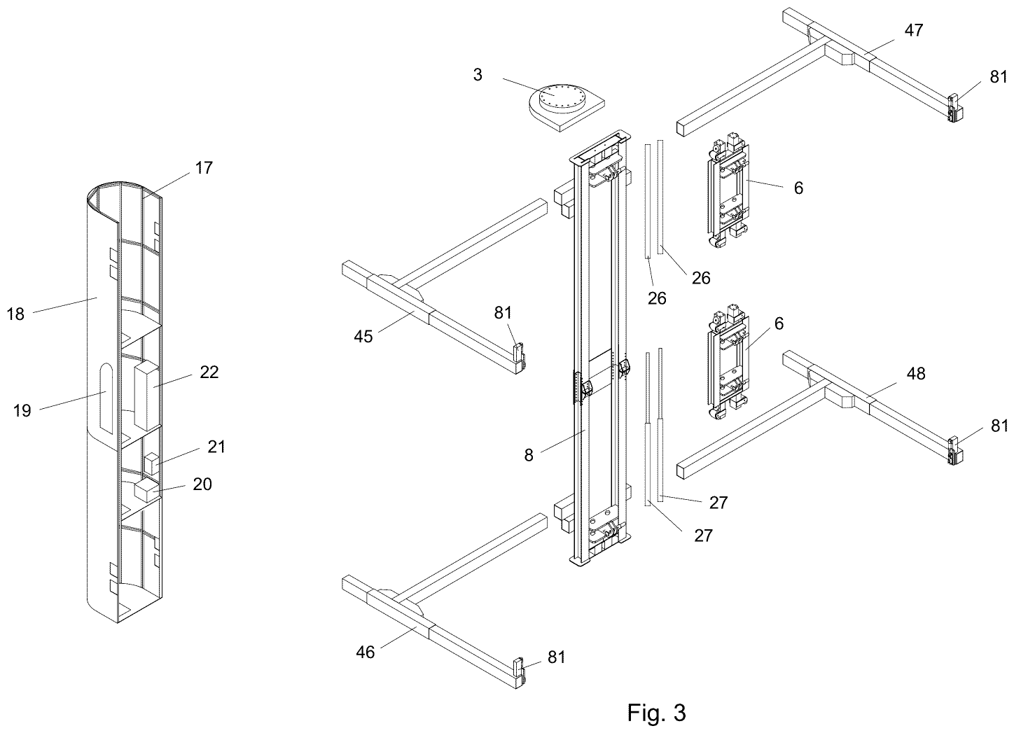

(003) FIG. 2 shows the general view of the climbing mechanism (1), and FIG. 3 shows the perspective views of its main components. The climbing mechanism (1) consists of the following main components.
Elevator (9) with coincident x, y, z axes, containing outer skid (8) and two inner skids (6), guide bearings (29) mounted on outer skid (8); Right and left side arms moving in x,y,z axes (45,46,47,48),
king pin U slots (90) on the side arms;
carrier chassis (17) and shell (18) mounted on the outer skid (8);
crane connection platform (3) mounted on the carrier chassis (17);

hydraulic tank (20) and hydraulic valve group (21) mounted inside the carrier frame (17) to operate the hydraulic cylinders and other hydraulic components in the climbing mechanism (1) and the crane (2);
electrical and electronic control panel (22) mounted inside the carrier cage system;
remote control room (5) located on the ground for remote control of the climbing mechanism (1) and the crane (2);

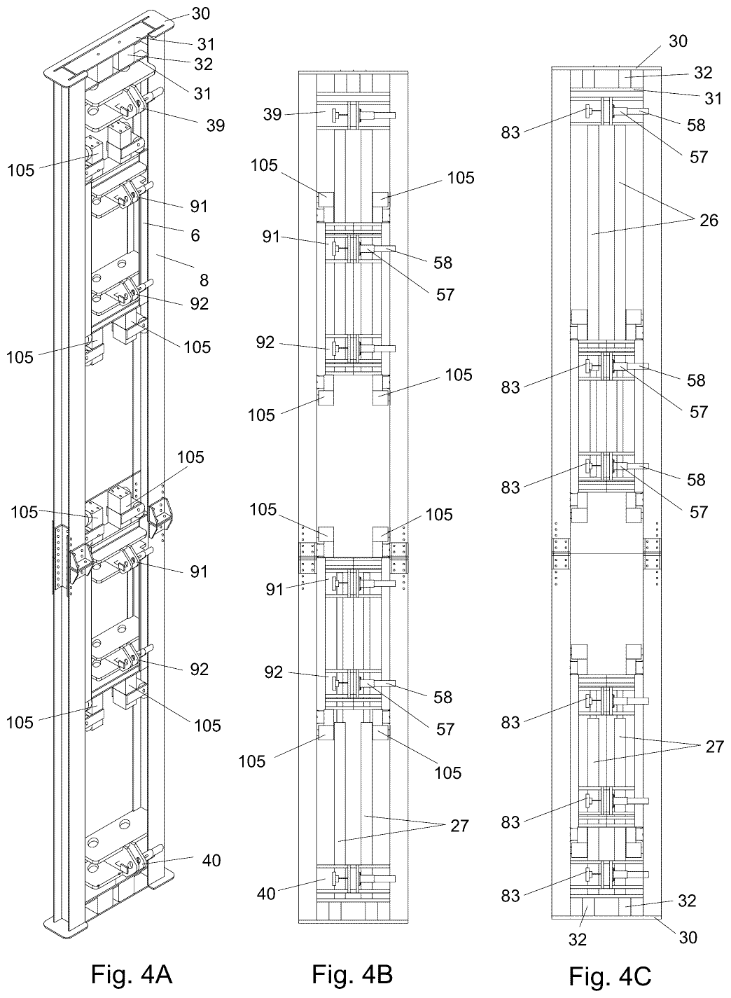

(004) FIG. 4B shows the perspective views of the outer skid (8), and FIG. 4A shows the main components of the outer skid (8). There are outer skid columns (42) on both sides of the outer skid (8), and reinforcement parts (30, 31 and 32) on its lower and upper edges. In addition, a durable structure is formed by strengthening it with reinforcement parts (30) in the direction of its height. The outer skid columns (42) can be made from standard NPI or NPU profiles. Or profiles with different cross-sections can be used. For ease of transportation, the outer skid (8) may be single or multi-piece. In FIG. 4A, the upper part of the two-piece outer skid (8) is shown as assembled and the lower part separated into its components.

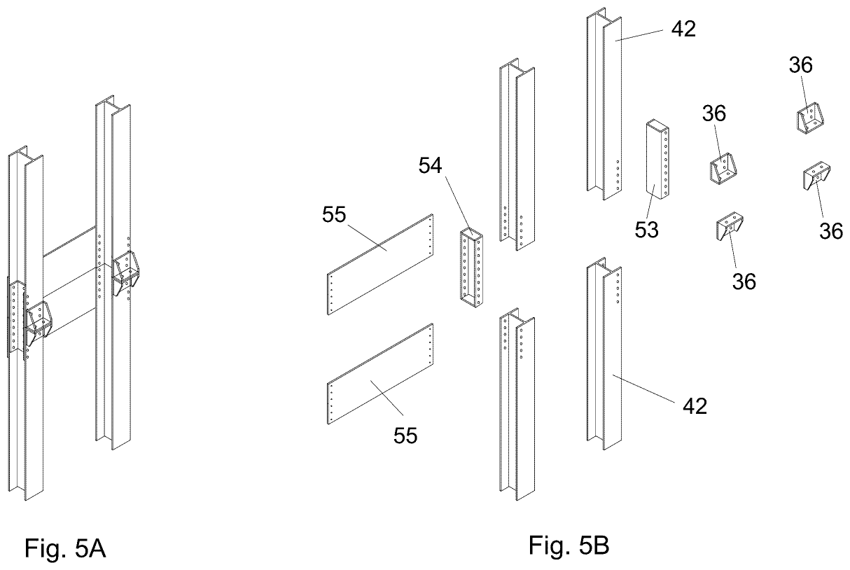

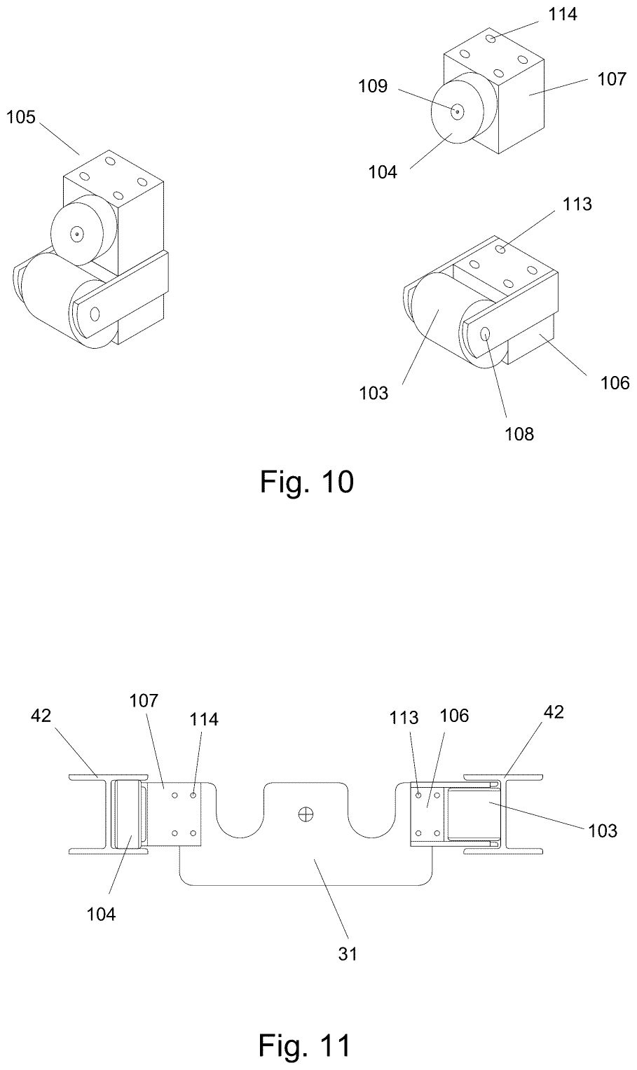

(005) In FIG. 5, the joint region in the skid columns (42) of the outer skid with two or more parts is shown enlarged. In the illustration, the outer skid columns 42 are shown in short length. FIG. 5B shows the assembly, FIG. 5A shows the views of the main components. The reinforcement parts (55) are fixed to the outer skid columns (42) by welding and bolts. Feders (36) and reinforcement parts (53 and 54) are welded and bolted to outer skid columns (42). The skid sections are attached or separated by bolts through the holes in the feders and reinforcement parts (36,53 and 54). All of the parts (36,53,54,55) used in the joint area are on the outer surfaces of the outer skid columns (42). Since the inner surfaces of the outer skid columns (42) are the surfaces on which the wheels (103 and 104) in the wheel group (105) operate, there are no additional parts (FIG. 10).

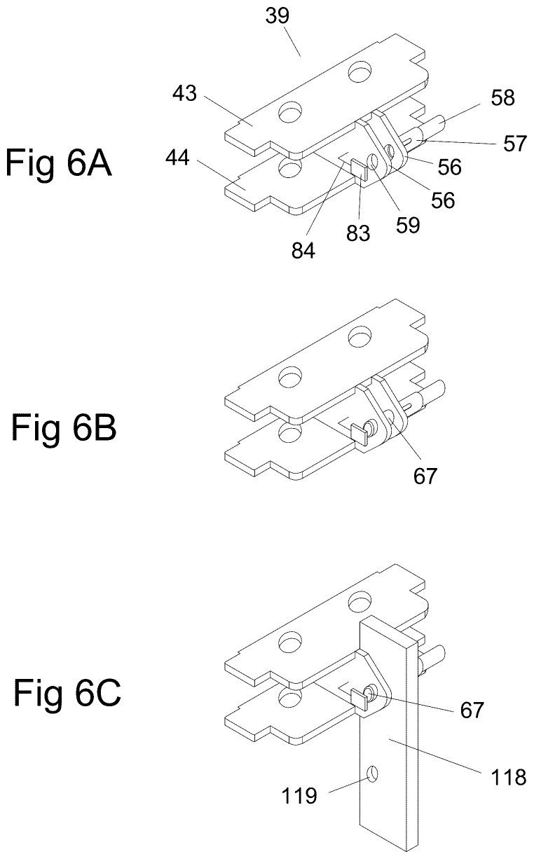

(006) There is one outer skid hanger parts (39 and 40) on the lower and upper parts of the outer skid (8) (FIG. 4). These hanger parts (39 and 40) are of the same construction. In FIG. 6, perspective views of the hanger part (39 and 40) are shown schematically. The outer skid (8) is fixed to the tower guide rail (118) by means of these hanger parts (39 and 40) (FIG. 6C). And at the same time, it transmits all the loads from the crane to the tower. The brackets (56) are welded to the reinforcement parts (43 and 44), the reinforcement parts (43 ve 44) are welded and bolted to the outer skid columns (42). The lock pin (67) moves in the guide tube (57) in the x-axis thanks to the hydraulic cylinder (58). The hydraulic cylinder (58) and guide tube (57) are fixed concentrically to the hole (59) in the bracket (56). When the outer skid (8) is moved up or down, the lock pin (67) is pulled into the guide tube 57 by the hydraulic cylinder 58 (FIG. 6A). When the upward or downward movement of the climbing mechanism (1) is completed, the lock pin (67) is driven into the hole (119) in the tower guide rail (118) by the hydraulic cylinder (58) (FIG. 6B). Thus, the outer skid (8) is fixed in its new position (FIG. 6C). The camera (83) used to monitor the position of the lock pin is fixed to the lock pin bracket (56) by the camera arm (84).

(007) There are four guide bearings 29 at the rear of the outer skid 8 (FIGS. 2A and 3A). Two of them are at the top and the other two are at the bottom. The side arms (45,46,47,48) are moved in the guide bearings (29) in the X axis by means of hydraulic cylinders (41) (FIG. 2).

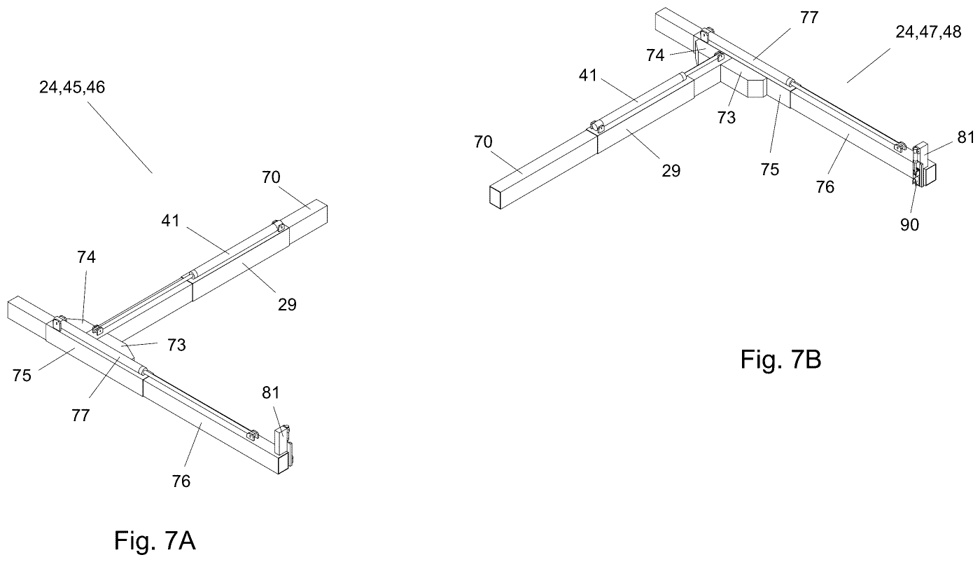

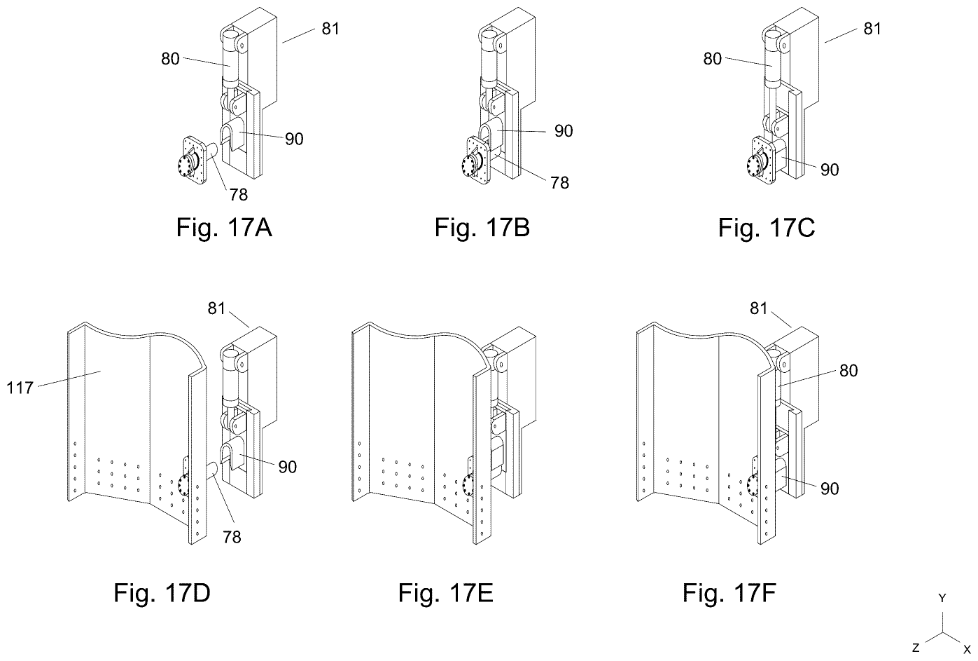

(008) In FIG. 7, there is a perspective view of the side arm assembly (24). There are four on the upper and lower parts of the climbing mechanism (1), on the right and left. The same side arm assembly (24) can be used as all four arms by changing the direction. The part numbers of the side arms are indicated as (45,46,47,48). In other words, the structure of all (45,46,47,48) is the same (FIG. 3). The side arm inner column (70) of the side arm is adjusted to the desired position by being moved in the X axis by means of the hydraulic cylinder (41) inside the guide bearing (29) mounted on the rear side of the outer skid (8). The other side arm guide bearing (75) is mounted on the end of the side arm inner column (70). There are corner reinforcement parts (73 and 74) to increase the rigidity of this joint. The side arm inner column (76) is adjusted to the desired position by moving it on the Z axis by means of the hydraulic cylinder (77) inside the side arm guide bearing (75). There is a U slot group (81) at the end of the side arm inner column (76). The U slot group (81) is fixed to the king pin (78) in the tower (FIG. 17), allowing the climbing mechanism (1) to be balanced on the tower (4). (Details will be described in the method of operation section (017) of the climbing mechanism below.)

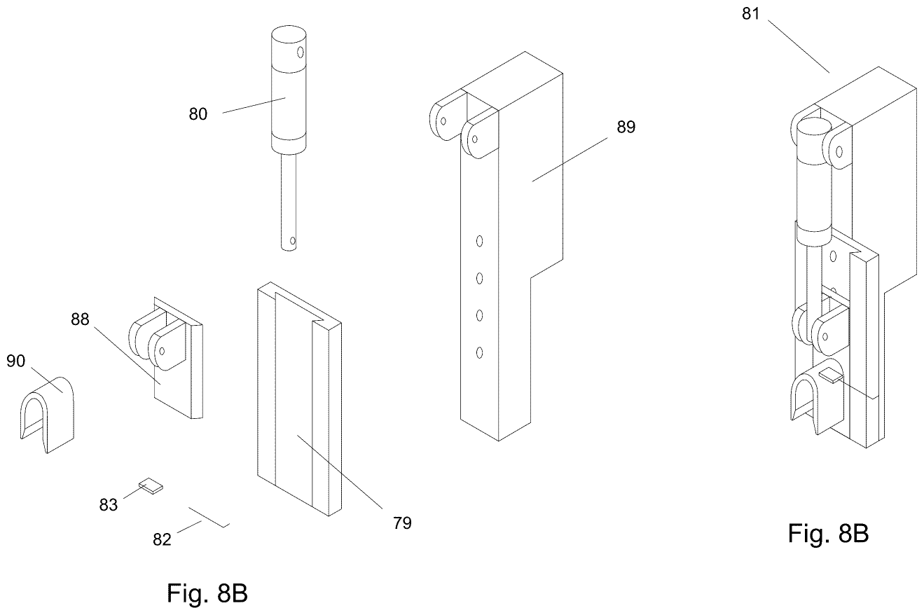

(009) Perspective views of the assembly and main components of the U slot group (81) are shown in FIG. 8. The side inner edges of the pool on the skid bearing (79) are in V form, and the slide skid part (88) with the same form on the sides works here. Brackets for hydraulic cylinder connection and U slot (90) are fixed on the skid skid part (88). The skid bearing 79 is fixed to the end portion of the side arm inner column 76 with reinforcement part (89) and ribs (FIG. 17), the skid bearing (79); the reinforcement part (89) and the feders are fixed to the end of the side arm inner column (76) (FIG. 17). The skid bearing (79) is fixed to the side arm inner column (76) by the reinforcement part (89) (FIG. 17). On the upper edge of the reinforcement part (89) there are brackets for the hydraulic cylinder connection. The camera (83) can be used to monitor the position of the U slot (90) and the king pin (78). The camera (83) can be attached to the reinforcement part (89) with the camera arm (82).

(010) When the climbing mechanism (1) is moved up or down to a new position, the axis of the U slot group (81) at the end of the side arm inner column (76) is moved along the X axis by hydraulic cylinders (41), the Z axis by hydraulic cylinders (77) to coincide with the axis of the king pin (78) on the tower (4). U

It may be necessary to precisely adjust the position of the U slot group (81) on the Y axis. To achieve this, the king pin U slot group (81) U slot (90) can be moved in the Y axis with the help of the hydraulic cylinder (80) in the skid bearing (79) (FIGS. 8 and 17). The axis of the U slot (90) is adjusted to coincide with the axis of the king pin (78) on the tower in the Y axis, and the hydraulic cylinder (80) and the U slot (90) are mounted on the king pin. This is done separately for each of the four side arms (45,46,47 and 48). While doing this, the position of the U slot (90) and the king pin (78) can be followed from the camera (83).

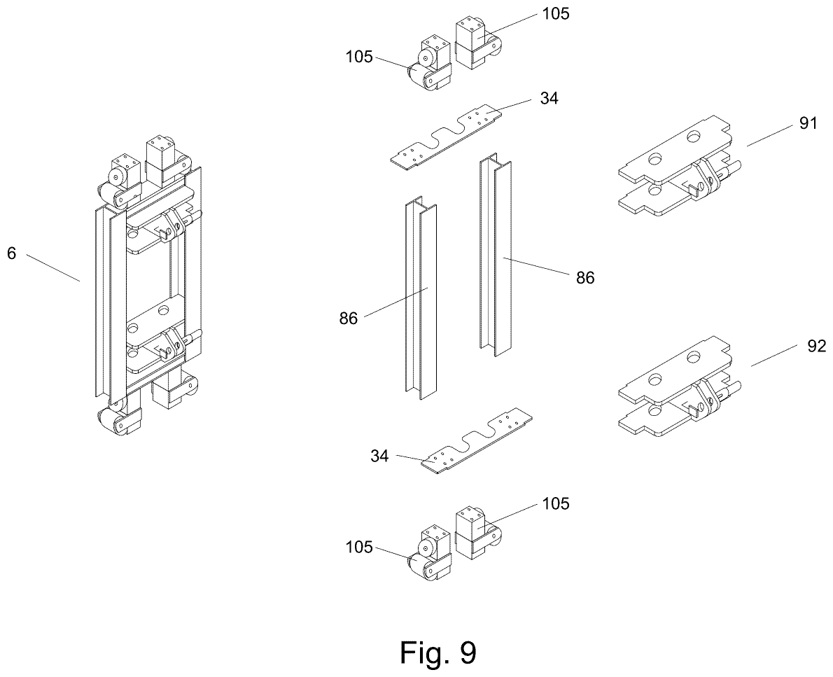

(011) FIG. 9 shows the perspective views of the inner skid (6) and its main components. There are skid columns (86) on both sides of the inner skid (6) and reinforcement parts (93 and 94) in the middle part (FIG. 9). The skid columns (86) can be made from standard NPI or NPU profiles. Or profiles with different cross-sections can be used. There are inner skid hanger parts (91 and 92) on the upper and lower edges of the inner skid (6). The inner skid (6) is fixed to the tower guide rail (118) by means of these hanger parts (91 and 92) (FIG. 6C). And at the same time, it transmits all the loads from the crane to the tower. All parts are combined with bolts and welding connections to form a rigid and safe structure.

(012) The structure and mode of operation of the inner skid hanger parts (91 and 92) at the lower and upper edges of the inner skid (6) is the same as that of the outer skid hanger parts (39 and 40) described in section (006) above.

(013) According to the invention, there are wheel groups (105) on the right and left corners of the lower and upper edges of the inner skid (6) (FIGS. 9 and 10). In FIG. 10 there are perspective views of the wheel group (105) and its main components. The upper wheel (103) is mounted to the bushing body (106) with the shaft (108) and the pin (110). Its task is to ensure that the inner skid (6) moves up and down in the Y-axis direction by forming a spaceless and frictionless structure in the X-axis inside the outer skid columns (42) (FIG. 4). The lower wheel (104) is mounted to the bushing body (107) with the shaft (109). Its task is to enable the inner skid (6) to move up and down in the Y-axis direction by forming a spaceless and frictionless structure in the Z-axis inside the outer skid columns (42). The wheels groups (105) are mounted on the right and left corners of the lower and upper edges of the inner skid (6) with bolts through the bolt holes (113 and 114). The wheel groups (105) are symmetrical to each other with respect to the X and Y axes of the inner skid (6). The condition of the wheel groups (105) inside the outer skid columns (42) (FIG. 4) is shown in FIG. 11 as the top view of the outer skid chassis. Thanks to this design, a spaceless and frictionless structure is formed in the X and Z axes inside the inner skid (6), the outer skid columns (42) and it is provided to move up and down in the Y axis direction.

(014) After each tower module (116) mounted on the tower (4), the climbing mechanism (1) must be moved up by the module height (H). The module heights of modular towers are generally around H=12 meters. In order to move the elevator (9) up to a height of H, the length of the outer skid (8) must be at least twice the height of the tower module (H). This distance means the useful distance that the inner skids (6) can move on the inside of the outer skid (8). If an inner skid is used, the elevator (9) moves by H for each movement. In this case, the height of the inner skid (6) must be at least H. In the elevator (9), the movements of the inner and outer skids (6 and 8) are provided by hydraulic cylinders and two hydraulic cylinders are used for each inner skid (6). If an inner skid (6) is used, the stroke of the hydraulic cylinders should be as much as H, that is, H=12 meters. In practice, during the operation of hydraulic cylinders with such a long stroke (H=12 m), there is a risk of bending and twisting of their shafts. To avoid these problems, two or more inner skids (6) can be used. In this case, the stroke (H/number of skids) of the hydraulic cylinders that move the skids will be in meters. If H=12 m and the number of inner skids (6) is two, the stroke of the hydraulic cylinders is (12/2=6 m) and a total of four hydraulic cylinders are used. In order to move the climbing mechanism (1) up or down by H meters, the elevator (9) is used by making two consecutive cycles. If H=12 m and the number of inner skids (6) is three, the stroke of the hydraulic cylinders is (12/3=4 m) and six hydraulic cylinders are used. In order to move the climbing mechanism (1) up or down by H meters, the elevator (9) is used by making three consecutive cycles.

This document describes a climbing mechanism using two internal skids (6) and four hydraulic cylinders (26 and 27). This means that the elevator (9) moves as much as H/2 (m) in each movement of the skids (6 and 8) (ie, in each cycle). In order to move the climbing mechanism (1) up or down by H meters, the elevator (9) is used by making two consecutive cycles.

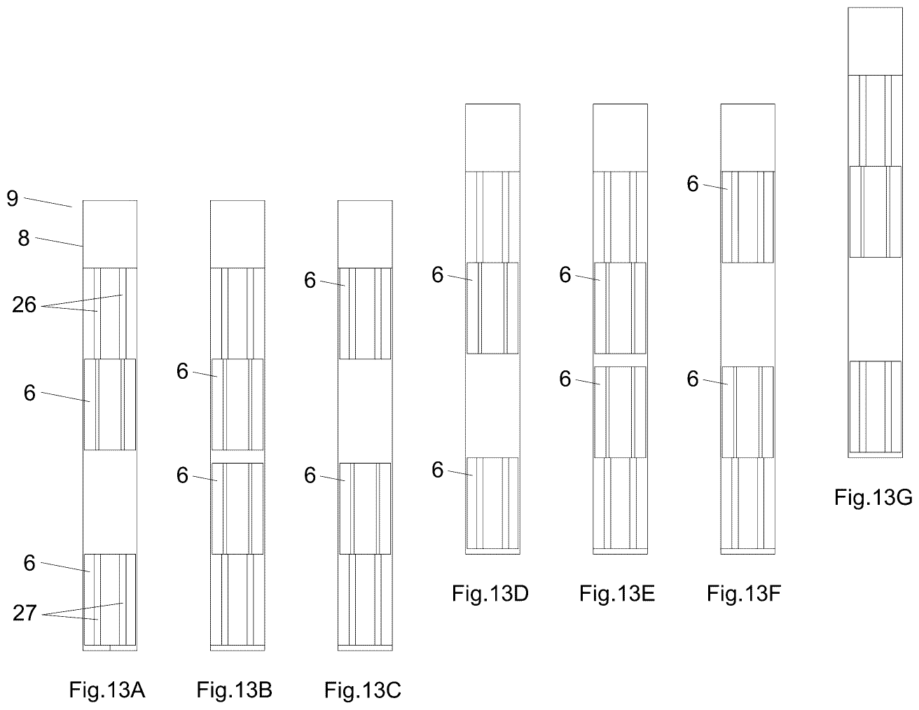

(015) According to the invention, the elevator (9) consists of two inner skids (6) moving in the Y axis inside the outer skid (8). The distance between the axes of the hole (59) in the hanger parts (91 and 92) of the inner skids (6) can be at most H/2 (meters) (FIG. 13). The distance between the axes of the hole (59) in the hanger parts (39 and 40) of the outer skid (8) must also be at least 2H (meters). The outer skid (8) is made in such a way that the useful distance that the inner skids (6) can move is at least 2H (m). That is, the total height of the outer skid (8) is more than 2H (meters).

(016) There are two hydraulic cylinders (26) fixed to the upper part of the outer skid (8), and two hydraulic cylinders (27) fixed to the lower part (FIGS. 13A and C). The strokes of the hydraulic cylinders (26 and 27) are about H/2 meters and they move the inner skids (6) in the Y axis. One end of the hydraulic cylinders (26) in the upper part is connected to the outer skid (8) and the other end is connected to the inner skid (6) at the top. One end of the hydraulic cylinders (27) in the lower part is connected to the outer skid (8) and the other end is connected to the inner skid (6) at the bottom. The inner skids (6) move down and up thanks to hydraulic cylinders (26 and 27) inside the outer skid columns (42). This allows the climbing mechanism (1) to move up or down on the Y axis. The climbing mechanism (1) is fixed to the tower guide rail (118) thanks to the hanger parts (39 and 40) on the outer skid (8) and the hanger parts (91 and 92) on the inner skid (6) (FIG. 6C). Details about the hanger part were explained in the section (006) above. (See also FIG. 4). The steps of the working method of the elevator (9) will be explained in the section (017) below.

(017) When the climbing mechanism (1) is desired to be moved upwards, (FIG. 13)
170—) There should be absolutely no load on the crane.
171—) The lock pins (67) on the upper inner skid (6) hanger parts (91 and 92) are pulled back with the help of hydraulic cylinders (58) and removed from the holes (119) in the guide rail (118) (FIGS. 6 and 13A);
172—) The upper inner skid (6) is moved upwards with the help of hydraulic cylinders (26) (FIG. 13B);
173—) The lock pins (67) on the upper inner skid (6) hanger parts (91 and 92) are pushed forward with the help of hydraulic cylinders (58) and attached to the holes (119) on the guide rail (118) (FIGS. 6 and 13B);
174—) The lock pins (67) on the lower inner skid (6) hanger parts (91 and 92) are pulled back with the help of hydraulic cylinders (58) and removed from the holes (119) in the guide rail (118) (FIGS. 6 and 13B);
175—) The inner skid (6) at the bottom is moved upwards with the help of hydraulic cylinders (27) (FIG. 13C);
176—) The lock pins (67) on the lower inner skid (6) hanger parts (91 and 92) are pushed forward with the help of hydraulic cylinders (58) and attached to the holes (119) on the guide rail (118) (FIGS. 6 and 13C);
Note 1: While making transactions numbered (171-176); tower connection of the climbing mechanism (1) is provided by lock pins (67) on the outer skid (8) hanger parts (39 and 40);
177—) The U slots (90) on the side arms (45,46,47 and 48) are first moved upwards in the Y axis with the help of hydraulic cylinders (80) and then pulled outwards by moving them in the x axis with the help of hydraulic cylinders (41). (FIGS. 2 and 17);
178—) The lock pins (67) on the outer skid (8) hanger parts (39 and 40) are withdrawn with the help of hydraulic cylinders (58) and removed from the guide rail (FIGS. 6 and 13C);
179—) The outer skid (8) is moved upwards with the help of hydraulic cylinders (26 and 27) (FIG. 1). At this time, the climbing mechanism (1) is fixed to the tower (4) only with the lock pins (67) on the hanger parts (91 and 92) of the inner skids (6). (four in total);
180—) The lock pins on the outer skid (8) hanger parts (39 and 40) are pushed forward with the help of hydraulic cylinders (58) and inserted into the holes on the guide rail;
Note 2: While making transactions numbered (177-180); the connection of the climbing mechanism (1) with the tower (4) is provided by the lock pins (67) on the hanger parts (91 and 92) on the inner skids (6);
Note 3: Steps 171-172 . . . 179 and 180 are the first cycle of climbing. At the end of the first cycle, the climbing mechanism (1) has risen half the height of the tower module (116);
181—) The steps 171-172 . . . 180 above are repeated in the same order. (FIGS. 13E-F and G). This completes the second cycle of climbing. The climbing mechanism (1) is moved upwards by the height of the tower module (116);
182—) The position of the U slots (90) on the side arms (45,46,47,48) is monitored by cameras (83) and adjusted on the x, y, z axes with the help of hydraulic cylinders (41,77,80) and fixed on the king pins (78) on the tower (45) (FIG. 17). See also FIGS. 2, 8 and 170. In this case, the crane is ready for use;

Thus, the climbing mechanism (1) is moved in an upward direction up to twice the stroke of the hydraulic cylinders (26 and 27), that is, H (m). Here, the movement of the inner skids (6) can be done simultaneously or separately. When the climbing mechanism (1) is desired to be moved downwards, the same process is done from the end to the beginning.

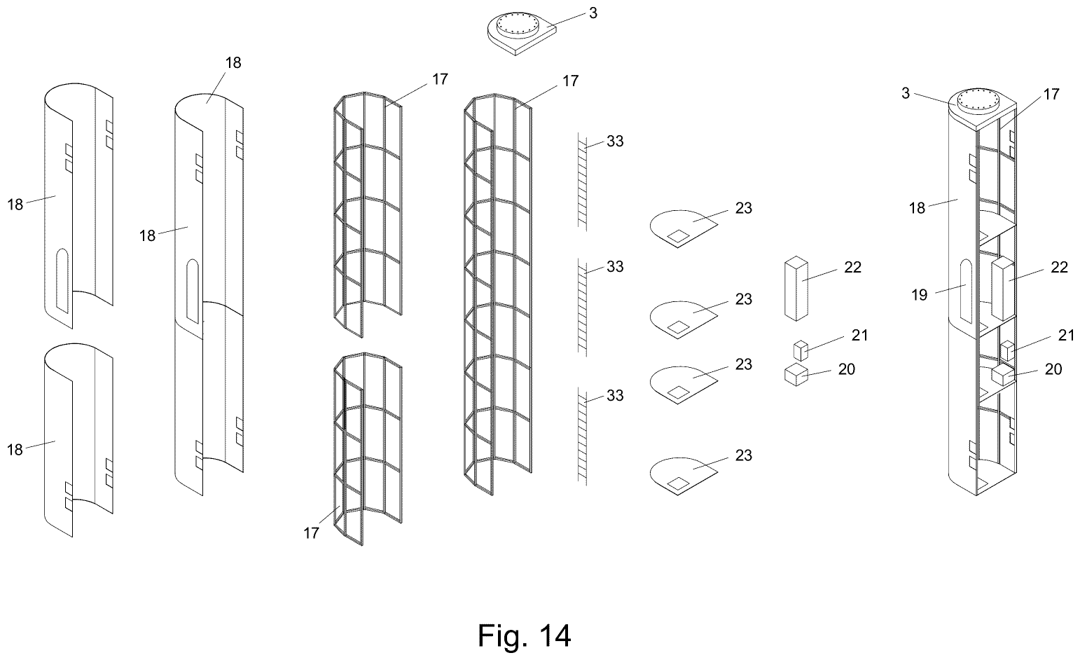

(018) In FIG. 14, there are perspective views of the carrier chassis (17) and the shell (18) as separate and assembled to each other. The carrier chassis (17) and the shell (18) can be produced in two or more modules for ease of transportation. The carrier chassis (17) is made of pipes and profiles and is fixed to the outer skid column (42) with bolts. There is a crane connection platform (3) on it. The loads coming from the crane (2) mounted on the connection platform (3) are transferred to the elevator (9) by means of the carrier chassis (17), and then to the tower (4) through the hanger parts (39,40,91,92) as a distributed load. There is a door (19) on the side of the carrier chassis (17). Inside, there are platforms (23) and stairs (33) (FIGS. 2 and 3). Hydraulic tank (20), hydraulic valve group (21), electrical and electronic control panel (22) are mounted on these platforms. Electricity is transmitted to the devices in the climbing mechanism thanks to the control panel. Electricity is transmitted to the devices in the climbing mechanism thanks to the electrical and electronic control panel (22).

(019) In order for the climbing mechanism (1) to be used in the assembly of the structure (for example, the wind turbine tower), there must be some special parts in the tower (4). These parts are planned in the design of the tower and produced together with the tower. These are elements such as guide rail (118), king pin slots (123), support rods (131).

(020) There is a guide rail (118) fixed to the tower element (117) so that the climbing mechanism (1) can hold onto the tower (4) and transmit the loads from the crane (2) to the base of the tower along with the tower elements (15 and 18). The guide rail (118) is fixed with bolts to the flanges (132) on the tower elements (117). The climbing mechanism (1) is fixed to the holes (119) on the guide rail (118) with the lock pins (67) in the hanger parts (39,40,91 and 92) located on the lower and upper edges of the outer and inner skids (6 and 8). The lock pins (67) are moved in the X axis by hydraulic cylinders (58) and inserted into the guide rail (118) holes (119) and removed. Details were explained in section (006) above.

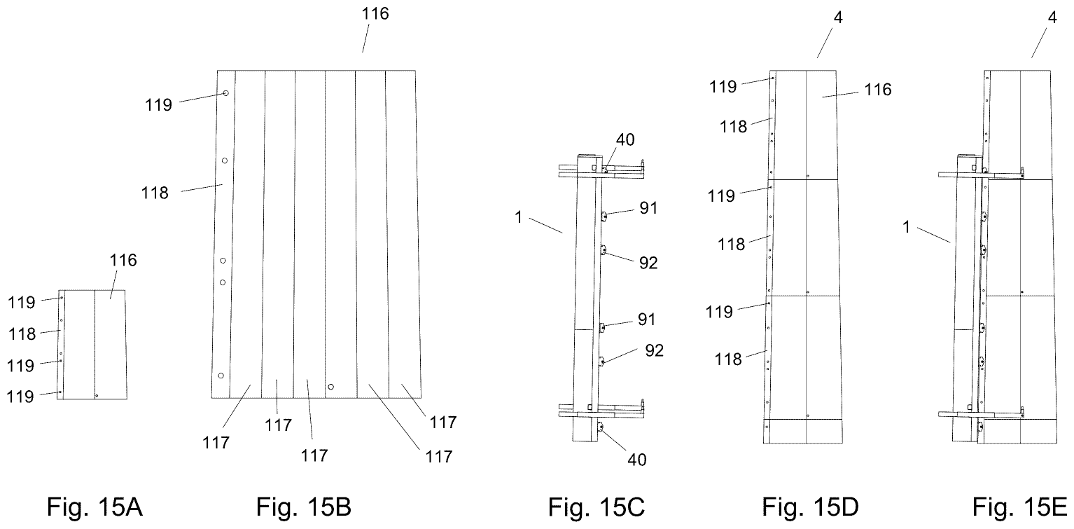

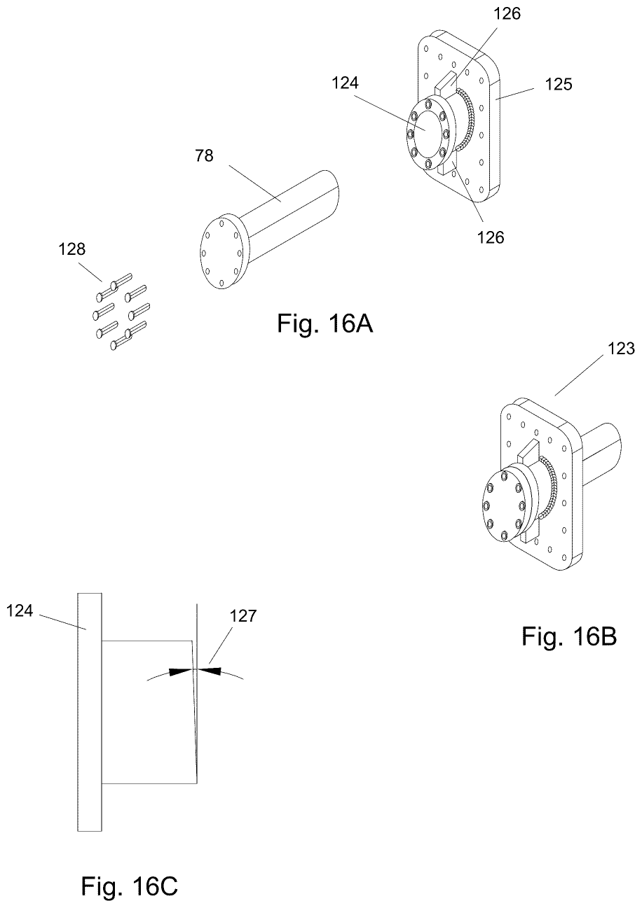

(021) It was explained in the above sections (008 . . . 010) that there are side arms (45,46,47,48) that provide the balance of the climbing mechanism (1) while lifting the load with the crane (2). There are king pins (78) on which U slots (90) are attached, enabling the side arms (45,46,47,48) to be fixed to the tower. The king pin (78) is fixed to the king pin slot (123). The king pin slot (123) is fixed to the tower element (117) with bolts (128) (FIGS. 16 and 17). The King pin slots (123) are mounted on two opposite tower elements (117) on each tower module (116) of the tower (4). The king pin bushing (124) is fixed to the metal plate (125) by welding. There are support plates (126) around it. A perspective view of the king pin slot (123) in FIG. 16B; its components are shown in FIG. 16A. The planes passing through the cylindrical surfaces of the King pin bushing (124) are not parallel to each other. Between them there is an angle (127), which is half the top angle of the tower. This feature, shown in FIG. 16C, ensures that the axes of the king pin (78) and the U slot (90) on the side arm coincide with each other. (See also FIGS. 15, 16 and 17).

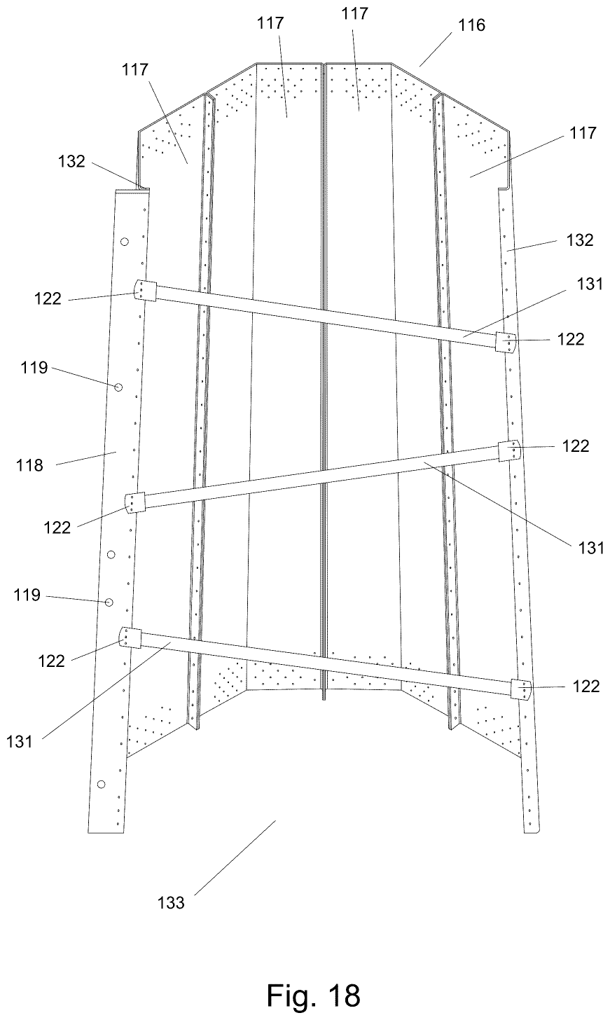

(022) The loads from the crane (2) are transmitted to the foundation via the guide rail (118) and tower elements (117). FIG. 18 shows the y-z cross-section (133) tower modules (116) according to the y-z plane. Support bars (131) can be used to balance the forces in the x, y and z axes on the guide rail (118) and to make it a distributed load. The support bars (131) are fixed to the flanges (132) on the tower member (117) with connecting parts (122) and bolts. The support bars (131) can be placed in line with the axes of polygonal or circular tower cross sections.

(023) There is a remote control room (5) on the floor to control the climbing mechanism (1). (FIG. 1). There is a remote control system in the remote control room (5). Hydraulic valves and crane (2) are operated by command from this remote control room (5). Communication between the remote control room (5) and the climbing mechanism is made by cables and signals from remote control devices. The climbing mechanism (1) is controlled by watching the images of the cameras (83) from this room.

(024) In FIG. 2, there is a perspective view of the climbing mechanism (1).

(025) FIG. 15E shows the first mounting condition of the climbing mechanism (1) on the tower (4). The crane (2) is mounted on the crane connection platform (3) and is made ready for use.

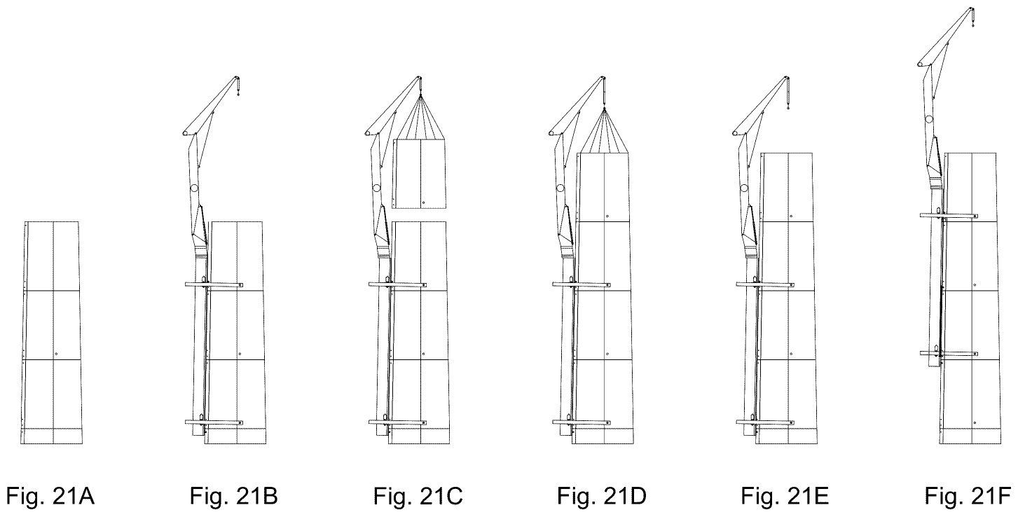

(026) The working method of the climbing mechanism is as follows.
201—) The first three modules of the tower (4) are mounted with a smaller crane than the larger cranes (FIGS. 20 and 21A);
202—) Then the climbing mechanism (1) is mounted on the tower (4) (FIGS. 15E and 21B).
203—) The crane (2) is mounted on the crane connection platform (3) (FIGS. 1 and 21B);
204—) The cables that will transmit electricity to the climbing mechanism are connected;
205—) The electrical-electronic communication system of the remote control room (5) and the climbing mechanism (1) is operated (FIG. 1);
206—) The position of the U slots (90) on the side arms (45,46,47,48) is monitored by cameras (83) and adjusted on the x, y, z axes with the help of hydraulic cylinders (41,77,80) and fixed on the king pins (78) on the tower (45) (FIG. 17). See also FIGS. 8 and 17. In this case, the crane is ready for use;
207—) The fourth module of the tower (4) is lifted by the crane (2) (FIG. 21C) and mounted on the third module (FIGS. 21D and 21E);
208—) The climbing mechanism (1) is moved upwards by applying the method described in the section (017) above. (FIG. 21F);
209—) Procedures numbered (207 and 208) are applied for each of the next modules and the tower (4) assembly is completed;
210—) Later, other elements of the wind turbine such as the nacelle, rotor and blades are lifted by crane and mounted in their places.
211—) Finally, the climbing mechanism (1) is lowered to the ground and removed from the tower;

### THE WAY THE INVENTION IS APPLIED TO INDUSTRY

The invention can be used for the assembly of wind turbines and similar structures by purchasing and installing a purpose-built crane after it has been manufactured at the factory.

1-17. (canceled)

18. The invention is a climbing mechanism (1) climbing upwards on the outer surface of a tower (4), wherein it has the characteristics in that;
it includes a steel construction carrier chassis (17) produced by welding and bolting large number of pipes and profiles to each other; which is having at least one elevator (9), platform (23) and stairs (33) fixed inside with welding and bolts, at least one crane connection platform (3) fixed on the upper side with welding and bolts, wherein the carrier chassis (17) is made in such a way that it can be divided into at least two parts to provide ease of transportation and assembly;
it includes at least one shell (18) with an inner and outer surface, made of steel or composite material, fixed to the carrier chassis (17) by bolts and welding, providing protection from external factors;
having at least two inner skids (6) moving in the Y-axis inside at least one outer skid (8), and hydraulic cylinders (26 and 27) that enable the skids (6 and 8) to move in the Y-axis; the carrier includes at least one elevator (9) fixed to the carrier chassis (17) by bolts and welding; wherein one end of the hydraulic cylinders (26 and 27) is fixed to the outer skid (8) and other ends are fixed to the inner skids (6);
outer skid (8) includes; skid columns (42) with U or I section on both sides, at least one reinforcement parts (36,53,54,55) with bolt holes that enable the longitudinal attachment or removal of the skid columns (42), at least four guide bearings (29) made of rectangular sections and mounted to the outer skid (8) by welding and bolts, at least one reinforcement parts (30 and 31) fixed on the lower and upper edges, hanger parts (39 and 40) and lock pins (67); wherein the reinforcements (30 and 31) and hanger parts (39 and 40) are welded and bolted to the skid columns (42); wherein the hanger parts (39 and 40) secure the outer skid (8) to the guide rail (118); wherein the material of all parts is steel;
the inner skid (6) includes skid columns (86) on both sides, at least one reinforcement part (34) and hanger parts (91 and 92) on the lower and upper edges, as well as wheel groups (105); wherein the wheel groups (105) are bolted to the reinforcement parts (34) at the four corners of the inner skid (6); wherein the reinforcement part (34) and hanger parts (91 and 92) are welded and bolted to the skid columns (86); wherein the wheel groups (105) are positioned symmetrically to each other with respect to the X and Y axes passing through the midpoint of the x-y plane of the inner skid (6); wherein the hanger parts (91 and 92) enable the inner skids (6) to be fixed to the guide rail (118); wherein the material of all parts is steel;
the wheel group (105) includes at least one wheel (103 and 104) and bushing body (106 and 107); wheels (103 and 104) are mounted to bushing bodies (106 and 107) by shafts (108 and 109); the bushing bodies (106 and 107) are in the form of rectangular prisms and contain bolt holes (113 and 114) enabling them to be fixed to each other and to the inner skid (6); wherein the wheel group (105) ensures that the inner skids (6) operate within the skid columns (42) of the outer skids (8) with minimum clearance and friction in the X and Z axes as they move in the Y axis;
hanger parts (39,40,91,92) includes at least two brackets (56) welded to reinforcement parts (43 and 44), at least one lock pin (67), guide tube (57), hydraulic cylinder (58) and the camera (83); wherein the brackets (56) include holes (59) for mounting to the guide rail (118); wherein the guide tube (57) is a piece of tube fixed to one butt bracket (56) and the other to the hydraulic cylinder (58); wherein, the locking pin (67) is moved in the X-axis thanks to the hydraulic cylinder (58) inside the guide tube (57), which allows the installation of the inner and outer skids (6 and 8) on the guide rail (118); wherein the camera (83) is to monitor the position of the lock pin (67) and the holes (119) in the guide rail (118);
includes at least one guide rail (118) having a plurality of holes (119) for engaging the lock pins (67) and at the same height as the tower element (117); wherein the guide rail (118) is bolted to the flanges (132) on the tower elements (117); wherein the guide rail (118) secures the climbing mechanism (1) to the tower (4) and transmits all loads from the climbing mechanism (1) to the tower foundation via the tower (4); wherein the guide rail (118) is made of steel material;
it includes at least four side arms (45,46,47,48) moving in the X axis by means of hydraulic cylinders (41) in the guide bearings (29) in the outer skid (8); wherein the side arms (45,46,47,48) allow the climbing mechanism (1) to be fixed to the tower (4) and prevent it from wobbling, wherein the side arms (45,46,47,48) includes, at least one side arm inner column (70), at least one guide bearing (75) welded to one end of the side arm inner column (70), at least one side arm inner column (76) moving in the Z axis by means of at least one hydraulic cylinder (77) in the guide bearing (75), at least one U slot group (81) welded and bolted to the end of the side arm inner column 76; wherein the side arm inner column (70), guide bearing (75) and side arm inner column (76) are made of rectangular steel profiles;
U slot group (81) contains; skid bearing (79) fixed to at least one reinforcement part (89) with bolts, at least one hydraulic cylinder (80), at least one skid part (88) moving in the Y axis inside the skid bearing (79) thanks to the hydraulic cylinder (80) U slot (90) and camera (83); wherein the skid bearing (79) is welded and bolted to the reinforcement part (89); wherein the U slot (90) is fixed to the skids part (88) by welding and bolts; wherein the U slot (90) is moved in the Y axis by the hydraulic cylinder (80) and attached to the king pin (78) on the tower element (117); wherein the camera (83) is to monitor the position of the U slot (90) and the king pin (78);
king pin slot (123) includes a king pin bushing (124) welded to a metal plate (125) with bolt holes and flat surfaces, and a king pin (78) fixed with bolts to a king pin bushing (124); wherein there is an angle (127) between the planes passing through the foreheads of the king pin bushing (124), half the top angle of the tower; this ensures that the center axes of the king pin (78) and the U slot (90) are coincident; wherein the king pin slots (123) and king pins (78) are bolted to the two opposing tower elements (117) of all tower modules (116,120);
it includes a large number of support bars (131), consisting of connecting parts (122), which are fixed to both ends of a piece of pipe by welding and screws; wherein the support bars (131) are bolted to the guide rail (118) and to the flanges (132) of the tower elements (117) directly opposite, through the holes in the connecting parts (122); wherein the axes of the support bars (131) pass through planes passing through the centers of the tower (4) sections; wherein the support bars (131) cause the forces on the guide rail (118) to become a distributed load;
it includes at least one crane connection platform (3), which has bolt holes enabling the crane (2) to be mounted to the climbing mechanism (1) and is fixed to the carrier chassis (17) by welding and bolts;
it includes at least one hydraulic tank (20), hydraulic valve group (21) and electrical and electronic control panel (22) mounted on the inside of the carrier chassis (17), enabling remote operation of the climbing mechanism (1) and the crane (2);
comprising at least one remote control room (5) located on the ground, enabling remote operation of the climbing mechanism (1) and the crane (2).

19. It is a climbing mechanism (1) according to claim 18; wherein it has the characteristics in that;
for the upward movement of the elevator (9); the locking pins (67) on the upper inner skid (6) hanger parts (91 and 92) are pulled back with the help of hydraulic cylinders (58) and removed from the holes (119) in the guide rail (118) and the upper inner skid (6) is as far as the stroke of the hydraulic cylinders (26) is moved upwards; the locking pins (67) are pushed forward by hydraulic cylinders (58) and inserted into the holes (119) in the guide rail (118); the lock pins (67) on the lower inner skid (6) hanger parts (91 and 92) are pulled back with the help of hydraulic cylinders (58) and removed from the holes (119) in the guide rail (118) and moved upwards as much as the stroke of the hydraulic cylinders (27); the locking pins (67) are pushed forward by hydraulic cylinders (58) and inserted into the holes (119) in the guide rail (118); U slots (90) on the side arms (45,46,47 and 48) are moved in x and y axes with the help of hydraulic cylinders (41 and 80) and removed from the king pins (78) in the tower (4); The lock pins (67) on the outer skid (8) hanger parts (39 and 40) are pulled back with the help of hydraulic cylinders (58) and removed from the holes (119) in the guide rail (118) and the outer skid (8) is moved up by hydraulic cylinders (26 and 27); the locking pins (67) are pushed forward by hydraulic cylinders (58) and inserted into the holes (119) in the guide rail (118); the same operations are done again; by monitoring the position of the U slots (90) on the side arms (45,46,47,48) from the cameras (83); in the X axis with the help of hydraulic cylinders (41); in the Z axis with the help of hydraulic cylinders (77); it is adjusted in the Y axis with the help of hydraulic cylinders (80) and fixed to the king pins (78) in the tower (4); it includes an elevator (9) that allows the climbing mechanism (1) to climb up as much as the module height and the same operations are performed from the end to the beginning for its downward movement.

20. It is a climbing mechanism (1) according to claim 18; wherein it has the characteristics in that;
after the first three modules of the tower (4) are mounted with a small crane, the climbing mechanism (1) is mounted in the holes (119) of the guide rail (118) in the tower (4) by means of the lock pins (67) on the outer skid (8) and the inner skid (6) hanger parts (39, 40, 91 and 92); electrical-electronic cable connections are made between the remote control room (5) and the climbing mechanism (1) and the electronic communication system is started; by monitoring the position of the U slots (90) on the side arms (45,46,47,48) from the cameras (83); it is adjusted on the X axis with the help of hydraulic cylinders (41), on the Z axis with the help of hydraulic cylinders (77), on the Y axis with the help of hydraulic cylinders (80) and fixed to the king pins (78) on the tower (4); thus the climbing mechanism (1) and the crane (2) are ready for use; the fourth module of the tower is lifted by the crane (2) and mounted on the third module; the elevator (9) of the climbing mechanism (1) is activated and the tower module (116) is moved upwards by its height; the same procedures are repeated for each of the next modules and the tower (4) assembly is completed; finally, the other elements of the wind turbine are lifted by crane and the assembly is completed; it is a climbing mechanism (1) that is lowered to the ground level and removed from the tower by applying all the processes in its upward movement from the end to the beginning.
